(19) United States
(12) Patent Application Publication
(10) Pub. No.: US 2006/0055728 A1
(43) Pub. Date: Mar. 16, 2006

(54) Tube pump and inkjet recording apparatus

(75) Inventor: Satoshi Nishino, Sayama-shi (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/220,037

(22) Filed: Sep. 6, 2005

(30) Foreign Application Priority Data
Sep. 10, 2004 (JP) JP2004-263919
Sep. 10, 2004 (JP) JP2004-263930

(51) Int. Cl. B41J 2/165

(52) U.S. Cl. 347/30

(57) ABSTRACT

A tube pump includes a housing section formed with a recession having an inner surface in an arc shape, a tube that is disposed along the inner surface at a mid portion of the tube and feeds UV-curable ink, a press member that is disposed on an opposite side to the inner surface with respect to the tube and moves a press position along a longitudinal direction of the tube by pressing the tube against the inner surface while eccentrically moving; and a transparent cover member that has a characteristic of shielding UV light and covers the recession.

This application is based on Japanese Patent Application No. 2004-263930 and Application No. 2004-263919 filed on Sep. 10, 2004, in Japanese Patent Office, the entire content of which is hereby incorporated by reference.

### FIELD OF THE INVENTION

The present invention relates to a tube pump for feeding UV-curable ink and inkjet recording apparatus provided with the tube pump.

### BACKGROUND OF THE INVENTION

Conventionally, there have been inkjet recording devices using UV-curable ink as a device for recording an image on a recording medium such as plain paper. Such an inkjet recording device jets UV-curable ink from inkjet nozzles of a recording head onto a recording medium, and irradiates UV-light from a light emitter to cure the ink on the surface of the recording medium to record an image.

In an inkjet recording device as described above, eccentric type tube pumps are used as a supply pump for supplying ink to a recording head and as a suction pump for sucking ink from inkjet nozzles of the recording head during maintenance (for example, see Patent Document 1).

Such a tube pump has a housing section formed with a recession with an arc shape inner surface, a tube of which mid portion is disposed along the inner surface of the recession, and a press member for pressing the tube against the inner surface of the recession of the housing section by eccentric motion, wherein ink is fed by successively moving the pressing position of the tube by the press member. In such a tube pump, UV light is shielded by covering the recession of the housing section with a black-colored cover member so that ink in the tube is prevented from getting cured.

However, if the recession of the tube pump is covered by a black-colored cover member, it is not possible to detect from outside a state where air is mixed in the portion of the tube in the recession, or a separation or crack occurs there. Therefore, it is necessary to remove the cover member for checking, which requires efforts for maintenance.

Further, the tube of such a tube pump preferably has a hardness with which the tube can be pressed and squashed, and preferably does not swell or get dissolved by ink. Therefore, a tube having a structure of a plurality of laminated layers is used (for example, see Patent Documents 2 and 3).

However, in a case where a tube having a laminated layer structure is used, a separation or crack tends to occur at a boundary portion between respective layers when the tube is pressed and squashed, which does not allow stable ink feeding.

[Patent Document 1] Patent publication No. 3501210

[Patent Document 2] TOKKAI No. 2004-181829

[Patent Document 3] TOKKAI No. 2004-1467

### SUMMARY OF THE INVENTION

An object of the invention is to provide a tube pump and an inkjet recording apparatus that allows easy maintenance.

Another object of the invention is to provide a tube pump and an inkjet recording apparatus that can stably feed ink.

In a first aspect of the invention, a tube pump includes a housing section formed with a recession having an inner surface in an arc shape, a tube that is disposed along the inner surface at a mid portion of the tube and feeds UV-curable ink, a press member that is disposed on the opposite side to the inner surface with respect to the tube and moves a press position along the longitudinal direction of the tube by pressing the tube against the inner surface while eccentrically moving; and a transparent cover member that has a characteristic of shielding UV light and covers the recession.

In a second aspect of the invention, in the tube pump in the first aspect, the tube includes an inner layer portion containing fluororesin and a transparent outer layer portion containing fluoro rubber material, wherein the inner layer portion and the outer layer portion are jointed to each other to form the tube.

### BRIEF DESCRIPTION OF THE DRAWINGS

FIG. 1 is a plan view of a schematic structure of an inkjet recording apparatus in accordance with the present invention;

FIG. 2 is a diagram illustrating an ink supply device and a maintenance unit;

FIGS. 3a and 3b are a cross-sectional view of respective tubes;

FIGS. 4a and 4b are isometric views of a supply pump;

FIG. 5 is a diagram illustrating operation of the supply pump;

FIG. 6 is a block diagram showing a schematic structure of the inkjet recording apparatus in accordance with the invention;

FIG. 7 is an isometric view of a schematic structure of an inkjet recording apparatus in a second embodiment in accordance with the invention; and

FIGS. 8a and 8b are diagrams illustrating operation of the inkjet recording apparatus during maintenance in the second embodiment.

### DETAIL DESCRIPTION OF THE PREFERRED EMBODIMENTS

The invention includes the following structures.

Item 1 A tube pump includes a housing section formed with a recession having an inner surface in an arc shape, a tube that is disposed along the inner surface at a mid portion of the tube and feeds UV-curable ink, a press member that is disposed on the opposite side to the inner surface with respect to the tube and moves a press position along the longitudinal direction of the tube by pressing the tube against the inner surface while eccentrically moving; and a transparent cover member that has a characteristic of shielding UV light and covers the recession.

Herein, the characteristic of shielding UV light is a characteristic of absorbing or reflecting UV light not to pass the UV light.

According to Item 1, as the cover member is transparent, it is possible to detect, from outside the cover member, a state where air is mixed in the portion of the tube in the recession, or a separation or crack occurs there. Therefore, it is unnecessary to remove the cover member for checking, which allows easy maintenance.

Further, as the cover member shields UV light, it is possible to prevent ink in the tube from getting cured by UV light.

Further, according to Item 1, the tube pump is a so-called eccentric type tube pump and feeds ink without squeezing the tube. Therefore, it is possible to reduce a load applied to the tube by this pump, such as a tension applied to the surface of the tube, compared with a roller type tube pump or the like. Thus, occurrence of a separation or crack in the tube can be prevented even in the case where the hardness of the tube is large due to a fluoro material.

Item 2 In the tube pump of Item 1, the cove member includes an acryl plate.

Herein, acryl has a high transparency while it does not pass UV light.

According to Item 2, as the cover member is an acryl plate having a high transparency, it is easier to check whether air is mixed in or a separation or crack has occurred.

Item 3 In the tube pump of Item 1 or 2, the cover member has a UV light absorbing layer.

Herein, the UV light absorbing layer can be, for example, a film formed by UV absorbing resin, a laminated layer of UV absorbing fine particles, or the like. As a method of forming a UV absorbing layer with a film, a film may be stuck on the surface of a substrate. As a method of forming a UV absorbing layer with minute particles, minute particles may be jetted or coated on the surface of a substrate.

According to Item 3, as the cover member has a UV absorbing layer, ink in the tube can securely be prevented from getting cured.

Item 4 In the tube pump of any one of Items 1 to 3, the cover member has a transparency rate greater than or equal to 1% for light with a wavelength in a range from 400 to 700 nm.

According to Item 4, as the cover member has a transparency rate greater than or equal to 1% for light with a wave length in a range from 400 to 700 nm, mixing in of air or occurrence of a separation or crack can securely be detected from outside the cove member.

Item 5 In the tube pump of any one of Items 1 to 4, the tube includes an inner layer portion containing fluororesin and a transparent outer layer portion containing fluoro rubber material, wherein the inner layer portion and the outer layer portion are jointed to each other to form the tube.

According to Item 5, the inner layer portion and the outer layer portion are jointed to form the tube, which makes a difference as follows from the case where an inner layer portion and an outer layer portion are laminated. That is, even when the tube is press-squashed by a press member and an inner surface of the recession, it is possible to prevent occurrence of a separation in a boundary portion between the inner layer portion and the outer layer portion. Accordingly, ink can be stably fed.

Further, as the inner layer portion contains a fluororesin, it is possible to prevent swelling or dissolution of the tube even with cation ink, making a difference from the case where the inner layer portion contains a fluoro rubber material.

Still further, as the outer layer portion is transparent, occurrence of a separation or crack in the boundary portion between the inner layer portion and the outer layer portion can be easily detected.

Yet further, since the outer layer portion contains a fluoro rubber material, lower hardness of the tube is allowed, compared with the case where the tube is formed only by a polypropylene resin, polyethylene resin, polytetrafluoroethylene resin, or a fluoroethylene polypropylene resin. Accordingly, the tube can be securely press-squashed by the press member to feed ink.

Item 6 In the tube pump of any one of Items 1 to 5, the portion of the tube disposed outside the recession has a black-colored layer.

According to Item 6, as the portion of the tube disposed outside the recession has a black-colored layer, it is possible to prevent UV light from passing into the tube. Accordingly, ink in the tube can securely be prevented form getting cured.

Item 7 In the tube pump of any one of Items 1 to 6, the tube feeds ink with a viscosity in a range from 10 to 50 [mPa·s] and a surface tension in a range from 20 to 40 [mN/m] at 25° C.

According to Item 7, similar effects to those of any one of Items 1 to 6 can be obtained.

Item 8 In the tube pump of any one of Items 1 to 7, the tube feeds ink containing a UV curable compound.

According to Item 8, similar effects to those of any of Items 1 to 7 can be obtained.

As the UV curable compound, oxetane compounds, epoxy compounds, vinyl ether compounds, or the like can be applied.

Item 9 An inkjet recording apparatus includes the tube pump described in any one of Items 1 to 8, a recording head for jetting ink supplied by the tube pump onto a recording medium, and a light emitter for irradiating light onto the recording medium.

According to Item 9, in the inkjet recording apparatus that supplies ink by the tube pump, similar effects to those of any of Items 1 to 8 can be obtained.

Item 10 An inkjet recording apparatus includes the tube pump described in any one of Items 1 to 8, a recording head for jetting photo-curable ink onto a recording medium, a light emitter for irradiating light onto the recording medium, and a cap member for covering the ink jetting face of the recording head during maintenance of the recording head, wherein the tube pump sucks ink from the ink jetting openings of the recording head through the cap member and transfers the ink to a discharge tank.

Herein, the ink jetting face is one of the surfaces of the recording head and is provided with the ink jetting openings.

According to Item 10, by the inkjet recording apparatus in which the tube pump sucks ink from the ink jetting openings, effects similar to those of any one of Items 1 to 8 can be obtained.

Now, preferred embodiments of the invention will be described below, referring to the drawings. Herein, the invention is not limited to the shown examples.

### First Embodiment

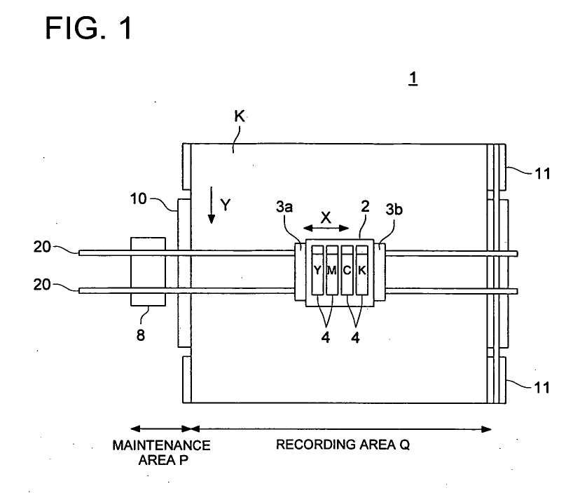

FIG. 1 is a plan view of a schematic structure of an inkjet recording apparatus 1 in accordance with the present invention.

As shown in the figure, the inkjet recording apparatus 1 includes a carriage 2.

The carriage 2 is reciprocally movable in scanning direction X, guided by guide members 20.

Light emitters 3a and 3b are mounted at the right and left ends of the carriage 2 to emit UV light downwards. As a UV light source to be used for the light emitters 3a and 3b, a low pressure mercury lamp, UV light laser, xenon flash lamp, insectivorous light, black light, bactericidal lamp, cold-cathode tube, LED high pressure mercury lamp, metal halide lamp, or an electrodeless UV light lamp can be employed, without limitation to these.

Four recording heads 4 are mounted between these light emitters 3a and 3b, which jet inks in the respective process colors of yellow (Y), magenta (M), cyan (C), and black (K), disposed along the scanning direction X.

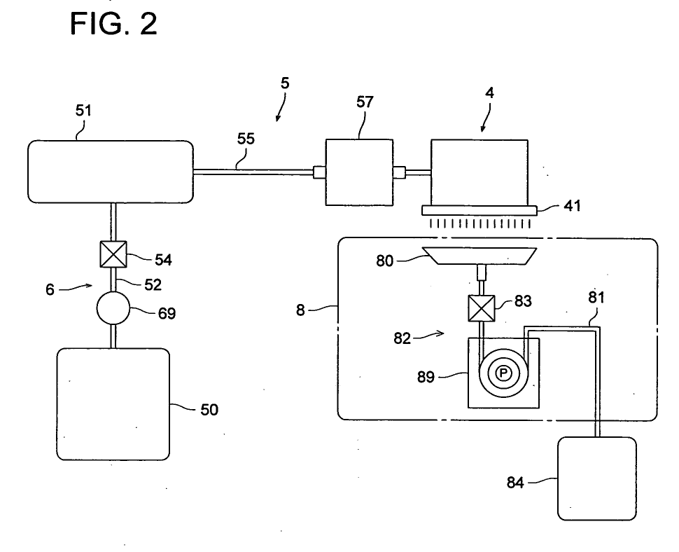

A plurality of ink jetting openings (not shown) is formed at the bottom face of each recording head 4, namely, the ink jetting face 41 (see FIG. 2).

Further, an ink supply device 5 is connected to the side portion of each recording head 4, as shown in FIG. 2. Herein, the carriage 2 or the guide members 20 are not shown in FIG. 2.

The ink supply device 5 includes a main tank 50 and a sub-tank 51 to store ink.

A supply pump 6 is connected to the main tank 50 and the sub-tank 51 to supply ink from the main tank 50 to the sub-tank 51.

The supply pump 6 is a tube pump in accordance with the invention and includes a tube 52 to feed ink and a pump section 69 having a pumping function.

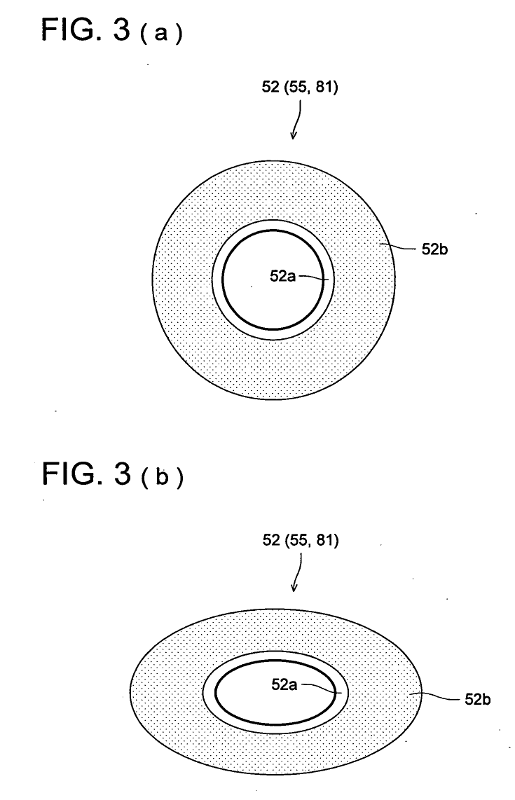

The tube 52, as shown in FIG. 3a, has a cross section in an approximate circular shape, wherein an inner layer portion 52a and outer layer portion 52b jointly form the tube 52. The hardness of the tube 52 is Shore A in a range from 70 to 80.

The inner layer portion 52a contains a fluororesin. As the fluororesin, PFA (perfluoroalkoxy resin), FEP (tetrafluoroethylene hexafluoropropylene copolymer), PTFE (tetrafluoroethylene, poly tetrafluoroethylene), or the like is employed. Thus, differently from a case where the inner layer portion 52a contains fluoro-rubber material, it is possible to prevent swelling or dissolution of the tube 52 even in a case the ink is cation ink.

The outer layer portion 52b contains a fluoro-rubber material. As the fluoro-rubber material, FKM (vinylidene fluoride rubber), FEPM (tetrafluoroethylene-propylene rubber), FFKM (tetrafluoroethylene-perfluorovinylether rubber), or the like is employed. Thus, the tube 52 has a lower hardness, compared with a case where the tube is formed only by polypropylene resin, polyethylene resin, polytetrafluoro-ethylene resin, or fluoro-ethylene-propylene resin. Accordingly, it is possible to press squash the tube 52 by the pump section 69 to feed ink.

Further, the outer layer portion 52b is black colored outside a pump section 69 to absorb UV light, and is transparent inside the pump section 69.

The tube 52 is provided with a supply valve 54 for control ink supply from the main tank 50 to the sub-tank 51, as shown in FIG. 2.

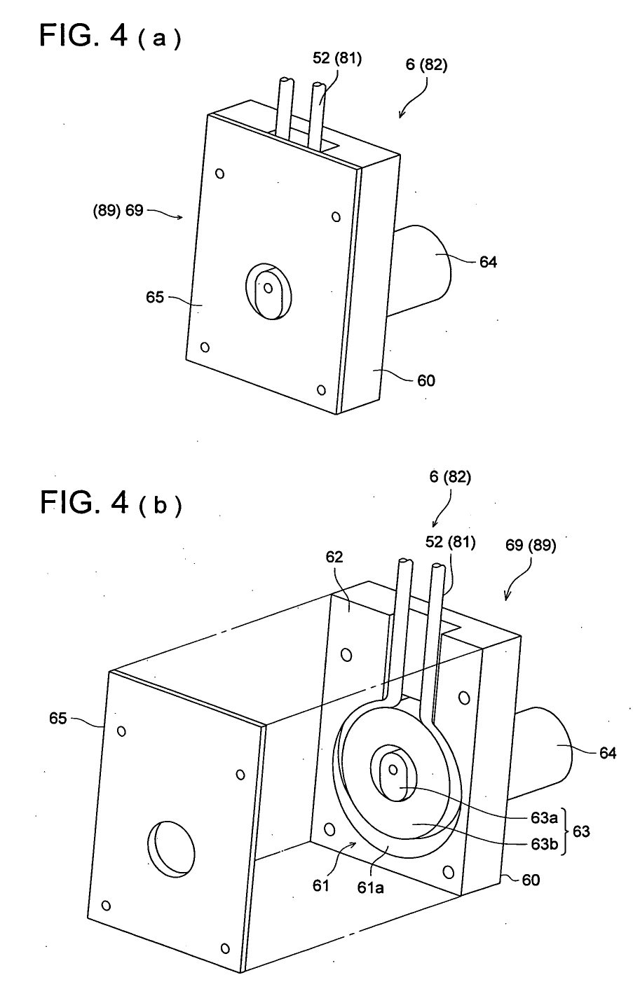

The pump section 69 includes a housing section 60 formed of resin and the like, as shown in FIGS. 4a and 4b.

A recession 61 having an inner surface 61a in an approximate circular shape is formed inside the housing section 60, and a guide opening 62 is formed in the upper part of the housing section 60, wherein the guide opening 62 is open at the top of the housing section 60 and communicated with the recession 61. The guide opening 62 guides the tube 52 from outside the housing section 60 into the recession 61, and thus the tube 52 is disposed along the inner surface 61a.

Further, a rotation shaft (not shown) that rotates driven by a motor 64 is arranged at the center of the recession 61. A press member 63 is fitted to the rotation shaft, with the tube 52 pressed against the inner surface 61a. The press member 63 includes an inner roller 63a and an outer roller 63b.

The inner roller 63a is in contact with the inner surface of the outer roller 63b and has an eccentric motion driven by the motor 64.

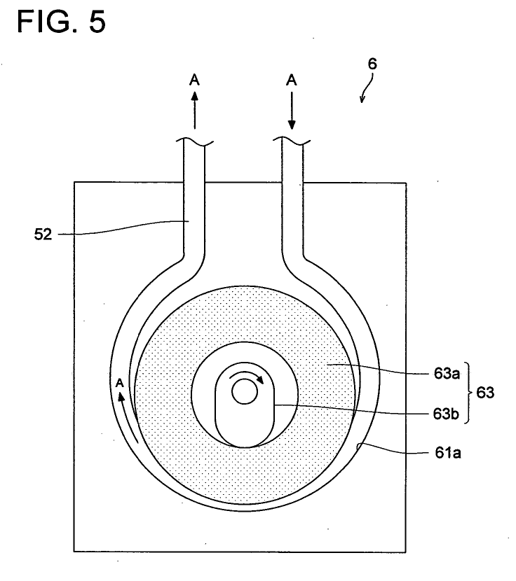

The outer roller 63b is in contact with the side surface of the tube 52 to press-squash the tube 52 cooperating with the inner surface 61a of the recession 61. The outer roller 63b has an eccentric motion, driven by the inner roller 63a, as shown in FIG. 5, to move the pressing-position along the ink feed direction A, thereby feeding ink.

As shown in FIGS. 4a and 4b, a cover member 65 is removably fitted to the side face of the recession 61 to cover the recession 61. In the present embodiment, the cover member 65 covers a side face of the housing section 60. The cover member 65 is a transparent member having a UV light shielding characteristic and a transparency rate greater than or equal to 1% for light with a wavelength in a range from 400 to 700 nm. In the present embodiment, an acryl plate forms the cover member 65.

Further, as shown in FIG. 2, the sub-tank 51 is connected with a tube 55 to supply ink from the sub-tank 51 to the recording head 4.

The tube 55 has a similar structure to the tube 52 and is provided with a damper 57.

The damper 57 inhibits fluctuation of the back pressure due to the reciprocal motion of the carriage 2 and the ink jetting operation of the recording head 4 so that the ink jetting operation of the recording head 4 is stabilized. The damper 57 is mounted on the carriage 2 as well as the recording head 4.

A platen 10 is arranged in recording area Q below the carriage 2 having the light emitters 3a and 3b, recording heads 4, dampers 57, and the like, to support a recording medium K from the back side, as shown in FIG. 1. Conveying devices 11 including rollers are disposed on the both sides of the platen 10. The conveying devices 11 intermittently convey the recording medium K supported by the platen 10 along conveying direction Y.

Further, a maintenance unit 8 is provided in maintenance area P below the carriage 2 to perform maintenance of the respective recording heads 4.

The maintenance unit 8 includes a cap member 80 to cover the ink jetting face 41 of a recording head 4 when the recording head 4 is in the maintenance area P.

The cap member 80 is movable up and down driven by a transfer device, not shown.

The cap member 80 is connected with a suction pump 82. The suction pump 82 is a tube pump in accordance with the invention. As sown in FIG. 2, the pump 82 includes a tube 81 to feed ink and a pump section 89 having a pumping function.

The tube 81 has a similar structure, as shown in FIG. 3, to the aforesaid tube 52. The tube 81 is provided with a leak valve 83 between the cap member 80 and the pump section 89. When the leak valve 83 is open, the inside of the cap member 80 communicates with the atmospheric air.

As shown in FIG. 4, the pump section 89 has a similar structure to the pump section 69 described above. This pump section 89 makes the space formed between the cap member 80 and the ink jetting face 41 of a recording head 4 to be in a negative pressure to suck ink from the ink jetting openings of the recording head 4 together with air bubbles and the like and discharges them into an ink-discharge tank 84.

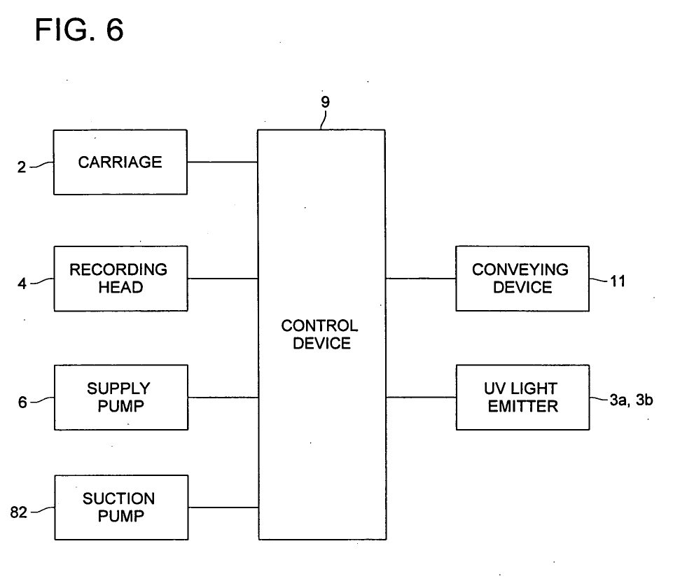

Further, as shown in FIG. 6, the inkjet recording apparatus 1 is provided with a control device 9 connected with the carriage 2, a conveying device 11, recording heads 4, supply pumps 6, suction pumps 82, and the like.

The control device 9 includes a ROM (Read Only Memory), RAM (Random Access Memory), and a CPU (Central Processing Unit) to control the operations of the respective sections of the inkjet recording apparatus 1.

Specifically, for example, the control device 9 controls the light emitters 3a and 3b to irradiate UV light, thereby curing ink on the surface of the recording medium K. The control device 9 further controls the conveying device 11 to intermittently convey the recording medium K. The control device 9 also controls the carriage 2 to move the recording heads 4 and the light emitters 3a and 3b in the scanning direction X. Still further, the control device 9 controls the supply pumps 6 and the suction pumps 82 to feed ink.

Next, “ink” used in the present embodiment will be described.

The ink used in the present embodiment is cured by UV light. The viscosity of this ink is in a rage from 10 to 50 [mPa·s] and the surface tension is in a range from 20 to 40 [mN/m] at 25° C.

Such UV curable inks can be broadly categorized into radical polymerization inks containing radical polymerization compounds and into cation polymerization inks containing cation polymerization compounds, as polymerizable compounds. Both types of inks are applicable to ink used in the present embodiment, and also a hybrid type ink, which is a mixture of a radical polymerization ink and a cation polymerization ink, may be applied to be used in the present embodiment. The ink in the present embodiment is cation polymerization ink which contains, at least, cation polymerization compounds, such as oxetane compounds, epoxy compounds, vinyl ether compounds, or the like, photo-cation initiator, and a color material.

Next, a “recording medium” used in the present embodiment will be described.

As the recording medium used in the present embodiment, materials can be applied which are made of plain papers used in a common inkjet recording device, recycle papers, various papers including gloss paper, various cloths, various non-woven cloths, resins, metals, glass, and the like. Regarding the shape of the recording medium, a roll form, a cut sheet form, a plate form, and the like can be applied.

Next, operation of the inkjet recording apparatus 1 during image recording will be described.

First, while conveying of the recording medium K by the conveying device 11 is stopped, the carriage 2 scans once just above the recording medium K along the scanning direction X. When the carriage 2 scans, the recording heads 4 scan following the carriage 2.

During this scanning, the ink jetting openings of the respective recording heads 4 jet ink onto the recording medium K. Thus, the ink jetted from the respective recording heads 4 reaches the recording medium K to be fixed on the surface of the recording medium K.

Then, if the ink amount in a sub-tank 51 has become small due to ink jetting by the recording head 4, the control device 9 controls the supply pump 69 to supply ink from the main tank 50 through the tube 52 to the sub-tank 51.

Herein, the cover member 65 has a UV light shielding characteristic, and the outer layer portion 52b of the part of the tube 52 disposed outside the recession 61 is black colored. Thus, UV light is prevented from passing into the tube 52, thereby ink in the tube 52 is prevented from getting cured by UV light. Further, the inner layer portion 52a and the outer layer portion 52b jointly form the tube 52, which makes a difference as follows from the case where an inner layer portion and an outer layer portion are just laminated. That is, even when the tube 52 is press-squashed by the press member 63 and the inner surface 61a of the recession 61, it is possible to prevent occurrence of a separation or crack in a boundary portion between the inner layer portion 52a and the outer layer portion 52b. Further, the supply pump 6 is a so-called eccentric type tube pump and feeds ink without squeezing the tube 52. Thus, a load applied to the tube 52, for example, the surface tension of the tube 52 are reduced, compared with a roller type tube pump or the like, so that occurrence of a separation or crack in the tube 52 is securely prevented.

Further, when a recording head 4 jets ink, the two light emitters 3a and 3b irradiate UV light onto the recording face of the recording medium. More specifically, while the carriage 2 is moving from the left to the right in FIG. 1, the light emitter 3a illuminates. In other words, the light emitter 3a, which is disposed after the recording heads 4 in the moving direction of the carriage 2, illuminates and irradiates UV light. In this way, ink jetted from each respective recording head 4 is exposed to UV light just after the ink reaches the recording medium, and gets cured instantly to be fixed on the recording face of the recording medium.

Next, the recording medium K is conveyed by the conveying device 11 in the conveying direction Y for a predetermined distance. Thereafter, the inkjet recording apparatus 1 repeats the respective operations described above, and thus, desired images formed by plural dots in the respective process colors are sequentially recorded on the surface of the recording medium K.

Next, operations of the inkjet recording apparatus 1 during the time of maintenance of the recording heads 4 will be described.

First, at the time of maintenance, the carriage 2 is moved into the maintenance area P.

Next, a cap member 80 rises and covers the jetting face 41 of a recording head 4.

In this state, the leak valve 83 is closed and the suction pump 82 is driven so that the air between the ink jetting face 41 of the recording head 4 and the cap member 80 is sucked. In this way, ink is sucked from the ink jetting openings of the recording head 4 together with foreign matters and air bubbles to be discharged into the discharge ink tank 84. At this moment, each recording head 4 may perform dummy jetting. Herein, since an inner layer portion 52a and an outer layer portion 52b jointly form the tube 81 in a similar way to forming a tube 52, even when the tube 81 is press-squashed by a pump section 89, it is possible to prevent occurrence of a separation or crack in the boundary portion between the inner layer portion 52a and the outer layer portion 52b. Further, since the suction pump 82 is an eccentric type tube pump similar to the supply pump 6, the load applied to the tube 81 is reduced, compared with a roller type tube pump or the like, thereby making it more secure to prevent occurrence of a separation or crack in the tube 81.

Further, in a state where the carriage 2 has moved into the maintenance area P, a worker can check whether air is not mixed into the tube 52 in the recession 61 of the supply pump 6 or whether a separation has not occurred in the tube 52. Herein, as the cover member 65 and the outer layer portion 52b, of the tube, disposed inside the pump section 69 are transparent, mixing in of air and occurrence of separation can be detected from outside the cover member 65.

In the above inkjet recording apparatus 1, since it is possible to detect mixing in of air and occurrence of separation in the tube 52 in the recession 61, from outside the cover member 65, it is unnecessary to remove the cover member 65 for checking, which allows easy maintenance.

Further, in the above inkjet recording apparatus 1, even when tubes 52 and 81 are press-squashed by pump sections 69 and 89, it is possible to prevent occurrence of a separation at a boundary between the inner layer portion 52b and the outer layer portion 52b, allowing stable feeding of ink.

Further, as the inner layer portion 52a contains fluoro resin, it is possible to prevent swelling or dissolution of the tube 52 due to cation ink, making a difference from the case where the inner layer portion contains a fluoro rubber material.

Still further, since the outer layer portion 52b contains a fluoro rubber material, lower hardness of the tube 52 is allowed, compared with the case where the tube is formed only by a polypropylene resin, polyethylene resin, polytetrafluoroethylene resin, or a fluoroethylene polypropylene resin. Accordingly, the tube 52 can be securely press-squashed by the press member 63 to feed ink.

### Second Embodiment

Next, a second embodiment of the invention will be described. Herein, elements which are the same as those in the first embodiment are designated by the same symbols, with the description of those omitted.

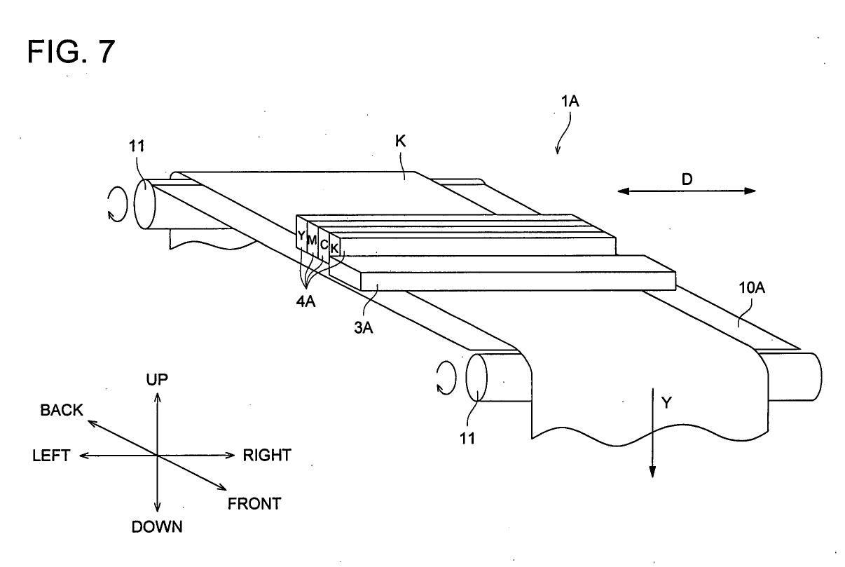

An inkjet recording apparatus 1A in the second embodiment is a line-head type inkjet recording apparatus provided with recording heads 4A and a light emitter 3A, as shown in FIG. 7.

The recording heads 4A are line type recording heads which jet ink in the respective process colors of yellow (Y), magenta (M), cyan (C), and black (K). These recording heads 4A are disposed in conveying direction Y, extending in arrow direction D parallel to the lateral direction of a recording medium K.

The light emitter 3a extends in arrow direction D and is disposed on the downstream side of the recording heads 4A in conveying direction Y

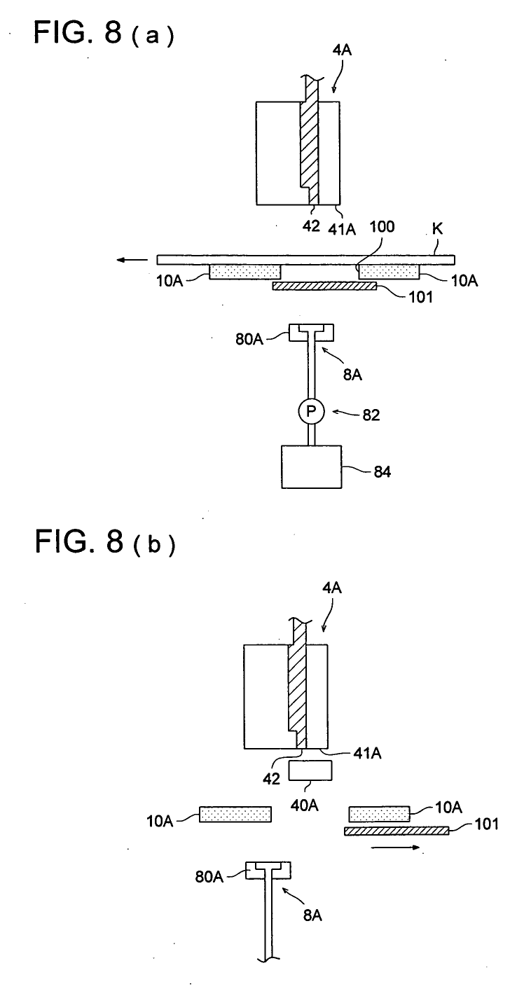

A platen 10 A is disposed below the recording heads 4A and the light emitter 3A. At the positions of the platen 10A facing the respective recording heads 4A, slits 100 are respectively formed extending in arrow direction D, as shown in FIG. 8.

The length of each slit 100 in arrow direction D is formed to be longer than the length between the ink jetting openings 42 which are at the left and right ends of a plurality of ink jetting openings 42 disposed on a recording head 4A. A shutter 101 is arranged under the slit 100 which opens and closes by a shutter driving mechanism (not shown). The shutter 101 is closed during image recording and open during maintenance, as shown in FIGS. 8a and 8b.

A maintenance unit 8A is disposed below the shutter 101. A cap member 80A of the maintenance unit 8A extends in arrow direction D and can cover the ink jetting face 41A of the recording head 4A.

Next, operations in maintenance of the above inkjet recording apparatus 1A will be described.

First, as shown in FIG. 8b, the shutter 101 opens, and the ink jetting face of a recording head 4A and the cap member 80A of the maintenance unit 8A face each other.

Next, the cap member 80A rises to cover the ink jetting face 41A of the recording head 4A. In this state, a suction pump 82 is driven to suck air between the ink jetting face 41A of the recording head 4A and the cap member 80A. Thus, ink is sucked from the ink jetting openings of the recording head 4A together with foreign matters and air bubbles to be discharged into a discharge ink tank 84. At this moment, the respective recording heads 41A may perform dummy ink jetting.

In the above inkjet recording apparatus 1A, the same effects as those by the inkjet recording apparatus 1 in the first embodiment can be obtained.

In the first and second embodiments, it was described that a cover member 65 is an acryl plate, the cover member 65 may be a transparent plate member having a UV light shielding characteristic, for which a UV absorbing film or a UV absorbing fine particle layer is provided on the surface of a substrate of transparent resin. Herein, the UV absorbing film can be, for example, T-UV FILM (trade name by TOCHISEN) or ACHILLES SEIDEN CRYSTAL UV (trade name by ACHILLES). The UV absorbing fine particles can be, for example, NEEDRAHL (trade name by TAKI CHEM CO LTD).

Although the tubes 52, 55, and 81 have been described to have a cross section in an approximate circular shape, they may have a cross section in an approximate ellipse shape, as shown in FIG. 3b.

Further, although it has been described that the outer layer portion 52b is a black-colored, it may be transparent. In this case, it is possible to easily detect an occurrence of a separation or crack in a boundary portion between the inner layer portion 52a and the outer layer portion 52b.

Still further, it has been described that the maintenance unit 8 is provided on the left side with respect to the platen, the maintenance unit 8 may be provided on the right side.

What is claimed is:

1. A tube pump, comprising:
a housing section formed with a recession having an inner surface in an arc shape;
a tube that is disposed along the inner surface at a mid portion of the tube and feeds UV-curable ink;
a press member that is disposed on an opposite side to the inner surface with respect to the tube and moves a press position along a longitudinal direction of the tube by pressing the tube against the inner surface while eccentrically moving; and
a transparent cover member that has a characteristic of shielding UV light and covers the recession.

2. The tube pump of claim 1, wherein the cove member comprises an acryl plate.

3. The tube pump of claim 1, wherein the cover member has a UV light absorbing layer.

4. The tube pump of claim 1, wherein the cover member has a transparency rate greater than or equal to 1% for light with a wavelength in a range from 400 to 700 nm.

5. The tube pump of claim 1, wherein the tube comprises an inner layer portion containing fluororesin and a transparent outer layer portion containing fluoro rubber material, and the inner layer portion and the outer layer portion are jointed to each other to form the tube.

6. The tube pump of claim 1, wherein a portion, of the tube pump, disposed outside the recession has a black-colored layer.

7. The tube pump of claim 1, wherein the tube feeds ink with a viscosity in a range from 10 to 50 [mPa·s] and a surface tension in a range from 20 to 40 [mN/m] at 25° C.

8. The tube pump of claim 1, wherein the tube feeds ink containing a UV curable compound.

9. An inkjet recording apparatus, comprising:
the tube pump of claim 1,
a recording head for jetting ink supplied by the tube pump onto a recording medium;
and a light emitter for irradiating light onto the recording medium.

10. An inkjet recording apparatus, comprising:
the tube pump of claim 1,
a recording head for jetting photo-curable ink onto a recording medium;
a light emitter for irradiating light onto the recording medium; and
a cap member for covering a jetting face of the recording head during maintenance of the recording head,
wherein the tube pump sucks ink from an ink jetting opening of the recording head through the cap member to transfer the ink to an ink discharge tank.
